(19) United States
(12) Patent Application Publication
(10) Pub. No.: US 2025/0370600 A1
(43) Pub. Date: Dec. 4, 2025

(54) METHOD, APPARATUS, DEVICE, AND STORAGE MEDIUM FOR INTERFACE INTERACTION

(71) Applicants: Beijing Zitiao Network Technology Co., Ltd., Haidian District (CN); Lemon Inc., Grand Cayman (KY)

(72) Inventors: Linyi Zheng, Beijing (CN); Tianhao He, CULVER CITY, CA (US); Chenman Zhou, Beijing (CN); Yujie Li, Beijing (CN)

(21) Appl. No.: 19/223,606

(22) Filed: May 30, 2025

Related U.S. Application Data
(63) Continuation of application No. PCT/CN2024/095855, filed on May 28, 2024.

(51) Int. Cl. G06F 3/0484; G06F 3/16

(52) U.S. Cl. CPC G06F 3/0484; G06F 3/165

(57) ABSTRACT

Embodiments of the disclosure relate to a method, apparatus, device, and storage medium for interface interaction. The method includes: presenting a play page of a content item based on content item data downloaded from a server, the play page comprising a play area for presenting image content of the content item, the play area comprising a first text container for presenting a first text content associated with the content item; in response to receiving a first operation, ceasing presenting the first text container and providing a second text container independent of the play area, the second text container being configured for presenting a second text content associated with the content item; and in response to receiving a second operation, presenting a detail page of the content item, the detail page comprising a third text container for presenting a third text content associated with the content item.

### CROSS-REFERENCE

This application claims priority to WO Patent Application No. PCT/CN2024/095855, filed on May 28, 2024 and entitled ‘METHOD, APPARATUS, DEVICE, AND STORAGE MEDIUM FOR INTERFACE INTERACTION’, which is incorporated herein by reference in its entirety.

### FIELD

Example embodiments of the present disclosure generally relate to the field of computers, and more particularly, to a method, apparatus, device, and computer-readable storage medium for interface interaction.

### BACKGROUND

In recent years, with the development of the Internet, more and more people view the contents of content items in online platforms. For example, people view various media content items with media platforms. However, traditional media platforms support playing media content items in a play page and presenting more information about the content items in a detail page. However, the traditional page interaction process is inefficient.

### SUMMARY

In a first aspect of the present disclosure, a method of interface interaction is provided, comprising: presenting a play page of a content item based on content item data downloaded from a server, the play page comprising a play area for presenting image content of the content item, the play area comprising a first text container for presenting a first text content associated with the content item; in response to receiving a first operation, ceasing presenting the first text container and providing a second text container independent of the play area, the second text container being configured for presenting a second text content associated with the content item; and in response to receiving a second operation, presenting a detail page of the content item, the detail page comprising a third text container for presenting a third text content associated with the content item, the third text content comprising a full text content of the content item and/or a review content of the content item.

In a second aspect of the present disclosure, an apparatus for interface interaction is provided, comprising: a presenting module configured to present a play page of a content item based on content item data downloaded from a server, the play page comprising a play area for presenting image content of the content item, the play area comprising a first text container for presenting a first text content associated with the content item; a first processing module configured to, in response to receiving a first operation, ceasing present the first text container and providing a second text container independent of the play area, the second text container being configured for presenting a second text content associated with the content item; and a second processing module configured to, in response to receiving a second operation, present a detail page of the content item, the detail page comprising a third text container for presenting a third text content associated with the content item, the third text content comprising a full text content of the content item and/or a review content of the content item.

In a third aspect of the present disclosure, an electronic device is provided, the device comprising at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the present disclosure, a computer readable storage medium having a computer program stored thereon is provided, the computer program being executable by a processor to implement the method in the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar drawing reference numerals denote the same or similar elements, wherein:

FIG. 1 illustrates a schematic diagram of an example environment capable of implementing some embodiments of the present disclosure in real time;

FIGS. 2A-2C illustrate example interfaces according to some embodiments of the present disclosure;

FIG. 3 illustrates a flowchart of an example process for session presentation according to some embodiments of the disclosure;

FIG. 4 illustrates a schematic structural block diagram of an example apparatus for session presentation according to some embodiments of the disclosure; and

FIG. 5 illustrates a block diagram of an electronic device capable of implementing various embodiments of the present disclosure.

### DETAILED DESCRIPTION

Embodiments of the present disclosure will be described in more details below with reference to the accompanying drawings. Although certain embodiments of the present disclosure are shown in the accompanying drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment.”. The term “some embodiments” should be understood as “at least some embodiments.” Other explicit and implicit definitions may further be included below. The terms “first”, “second”, etc. may refer to different or identical objects. Other explicit and implicit definitions may further be included below.

Embodiments of the present disclosure may relate to data, obtaining and/or use of data, etc. by a user, all following respective legal regulations and related regulations. In embodiments of the present disclosure, all data collection, obtaining, processing, processing, forwarding, use, and the like, are made with user knowledge and confirmation. Correspondingly, in implementing each embodiment of the present disclosure, the type, scope of use, and application scenario of the data or information that may be involved should be communicated to the user and the authorization of the user should be obtained by appropriate means in accordance with relevant laws and regulations. The specific manner of informing and/or authorizing may vary according to the actual situation and application scenario, and the scope of the present disclosure is not limited in this respect.

In this specification and the programs in the embodiments, if the processing of personal information is involved, the processing will be carried out on the premise that there is a basis of legality (e.g., consent of the subject of the personal information or it is necessary to fulfill a contract, etc.). Further, the processing will be carried out only within the scope of the stipulations or agreements. The refusal of the user to process personal information other than that which is necessary for the basic functions will not affect the use of the basic functions by the user.

As mentioned briefly above, traditional media platforms support the playing of media content items, e. g., video content items, graphic content items, etc., in a play page. In addition, the user can further present more information of the content item in the detail page, e. g., a full text content, etc. However, traditional solutions have a more compartmentalized design for the two pages, making it difficult for people to efficiently make the transition between pages to get the desired information.

Embodiments of the present disclosure provide a solution for interface interaction. According to the solution, a play page of a content item can be presented based on content item data downloaded from a server, the play page comprising a play area for presenting image content of the content item, the play area comprising a first text container for presenting a first text content associated with the content item; in response to receiving a first operation, presenting the first text container is ceased and a second text container independent of the play area is provided, the second text container being configured for presenting a second text content associated with the content item; and in response to receiving a second operation, a detail page of the content item is presented, the detail page comprising a third text container for presenting a third text content associated with the content item, the third text content comprising a full text content of the content item and/or a review content of the content item.

In this manner, embodiments of the present disclosure are able to provide a transition page between a play page and a detail page of a content item, enabling a user to naturally and smoothly jump from the transition page to the detail page, which is able to improve the efficiency of displaying the content of the detail page of the content item and the user experience.

Various example implementations of the embodiments are further described in detail below in connection with the accompanying drawings.

### Example Environment

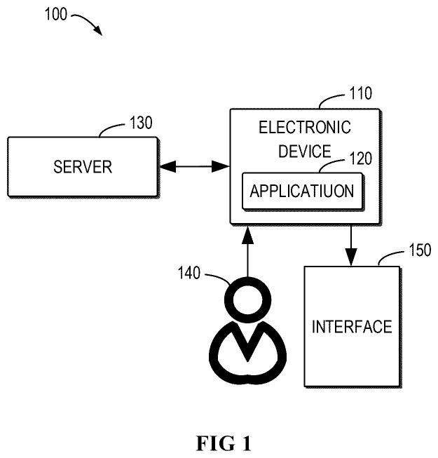

FIG. 1 shows a schematic diagram of an example environment 100 in which embodiments of the present disclosure can be implemented. As shown in FIG. 1, the example environment 100 can include an electronic device 110.

In this example environment 100, the electronic device 110 may be running an application 120 that supports interface interaction. The application 120 may be any appropriate type of application for interface interaction, examples of which may include, but are not limited to: a video application, a social application, or other appropriate application. A user 140 may interact with the application 120 via the electronic device 110 and/or an attached device thereof.

In the environment 100 of FIG. 1, if the application 120 is in an active state, the electronic device 110 may present an interface 150 for supporting interface interaction via the application 120.

In some embodiments, the electronic device 110 communicates with a server 130 to implement the provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a handheld computer, a portable gaming terminal, a VR/AR device, a Personal Communication System (PCS) device, a personal navigation device, a Personal Digital Assistant (PDA), an audio/video player, a digital camera/camcorder, a locator device, a television receiver, a radio receiver, an e-book device, a gaming device, or any combination thereof, including accessories and peripherals for such devices or any combination thereof. In some embodiments, the electronic device 110 can further support any type of user-specific interface (such as “wearable” circuitry).

The server 130 may be a stand-alone physical server, a server cluster or distributed system comprising a plurality of physical servers, or a cloud server providing basic cloud computing services such as cloud services, cloud databases, cloud computing, cloud functions, cloud storage, network services, cloud communications, middleware services, domain name services, security services, content distribution networks, and big data and artificial intelligence platforms. The server 130 may, for example, include a computing system/server, such as a mainframe, an edge computing node, a computing device in a cloud environment, and the like. The server 130 may provide backend services for the application 120 that support virtual scenarios in the electronic device 110.

A communication connection may be established between the server 130 and the electronic device 110. The communication connection may be established by wired means or wireless means. The communication connection may include, but is not limited to, a Bluetooth connection, a mobile network connection, a Universal Serial Bus (USB) connection, a Wireless Fidelity (WiFi) connection, etc., and embodiments of the present disclosure are not limited in this regard. In embodiments of the present disclosure, the server 130 and the electronic device 110 may implement signaling interactions through a communication connection therebetween.

It should be understood that the structure and function of the various elements of the environment 100 are described for the example purposes only and do not imply any limitation on the scope of the present disclosure.

Some example embodiments of the present disclosure will continue to be described below with reference to the accompanying drawings.

### Example Interactions

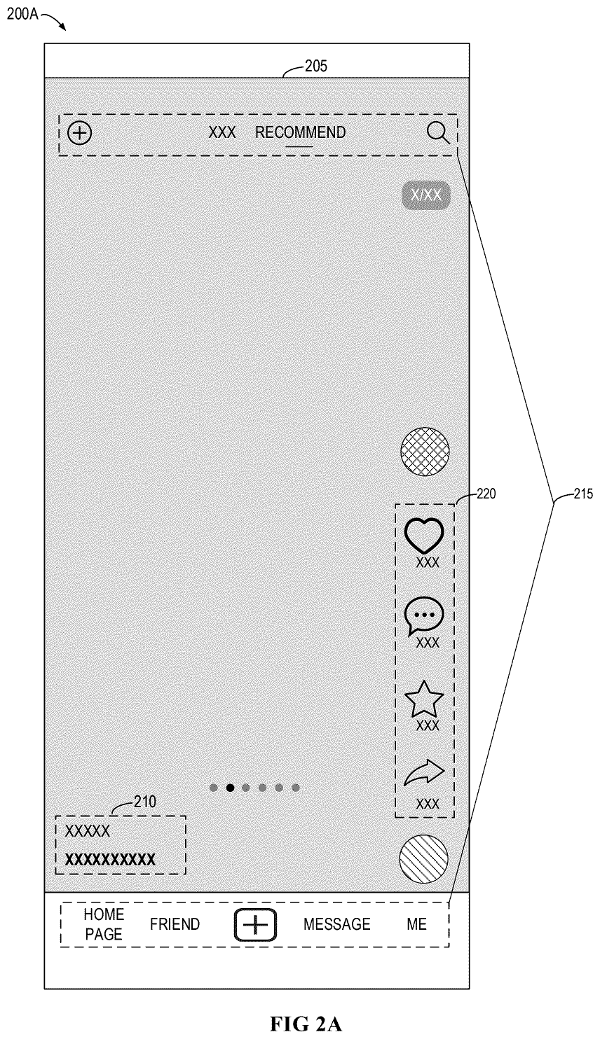

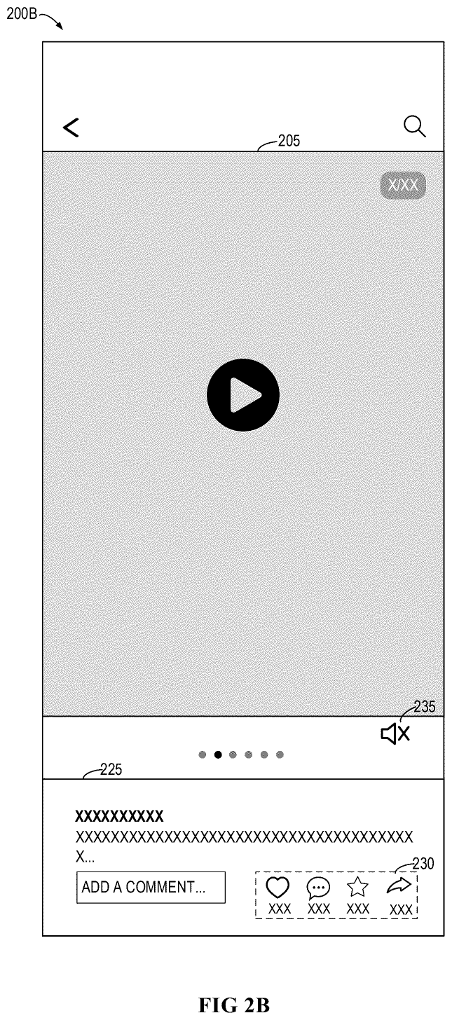

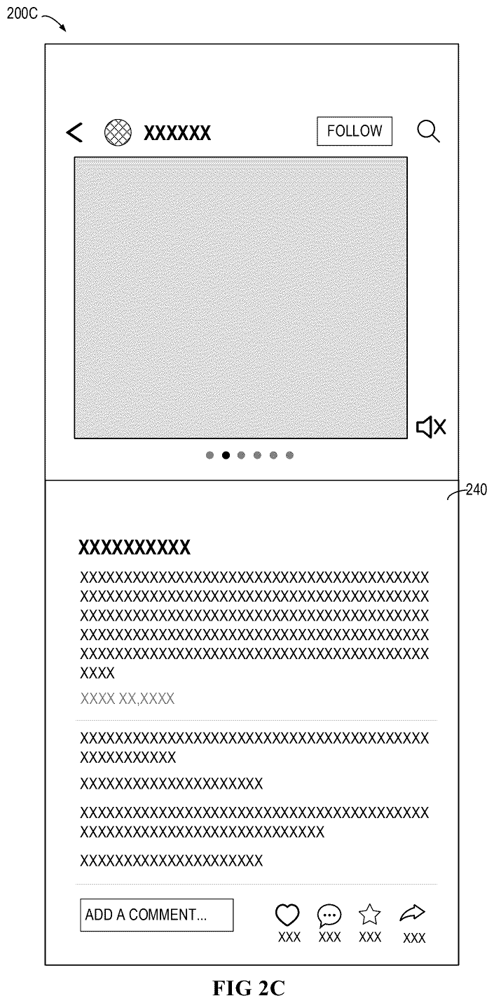

FIGS. 2A-2C illustrate example interfaces 200A-200C, according to some embodiments of the disclosure. The interfaces 200A-200C, for example, may be provided by the electronic device 110 shown in FIG. 1.

In some embodiments, the electronic device 110 may present the play page 200A of the content item in FIG. 2A with the content item data downloaded from the server. By way of example, the type of content item may be a video type, a music type, an image-text type, a text type, etc.

In some embodiments, with reference to FIG. 2A, the electronic device 110 may play a content item, which may include a video or a plurality of images, based on the play page 200A.

In some embodiments, as shown in FIG. 2A, the play page 200A includes a play area 205 for presenting an image content of a content item. The electronic device 110 may further provide a first text container 210 in the play area 205. The first text container 210 may present a first text content associated with the content item. As an example, the first text content may include a title of the content item, an author name, a content item introduction, etc. As an example, due to the limitation of the picture size, the first text content presented in the first text container 210 may include a part of the content of the introduction of the content item and the like.

In some embodiments, with continued reference to FIG. 2A, the electronic device 110 may further present a plurality of labels (e. g., topic labels) associated with the content item with the first text container.

In some embodiments, with continued reference to FIG. 2A, the electronic device 110 may further provide a set of display components 215 in the play page 200A. The set of display components 215 can be used to switch a display content in the play page 200A or to jump to other interfaces. For example, the set of display components 215 may include a message display component. Further, the electronic device 110 may, in response to a trigger of click on the message display component, display a message interface of the user.

In some embodiments, with continued reference to FIG. 2A, the electronic device 110 may further provide a set of interactive components 220 in the play page 200A. The set of interactive components 220 may be used for a user to perform an interactive action on the content item in the play page 200A. For example, the set of interactive components 220 may include a like component. Further, the electronic device 110 may, in response to a trigger of the like component, record the action of the user liking the content item.

In some embodiments, with continued reference to FIG. 2A, the electronic device 110 can receive a first operation (e. g., a click operation) on the play page 200A, and present the play page 200B as shown in FIG. 2B.

In some embodiments, with reference to FIG. 2B, in response to receiving the first operation, the electronic device 110 may further cease presenting the first text container 210 in the display page 200B. Further, the electronic device 110 may also provide a second text container 225 independently of the play area 205. The second text container 225 may be configured to present a second text content associated with a content item. As an example, the second text content may include a title of the content item, an author name, a content item introduction, etc.

In some embodiments, the second text container 225 has a predetermined size that is independent of the length of the full text content of the content item. That is, the size of the second text container 225 is not affected by the length of the full text content of the content item.

In some embodiments, with continued reference to FIG. 2B, in response to receiving the first operation, the electronic device 110 can further control the display page 200B to cease playing the content item.

In some embodiments, with continued reference to FIG. 2B, in response to the first operation, the electronic device 110 may further cease presenting a set of display components 215 in the play page 200B. In this way, it is beneficial for the user to view the image content and the second text content of the content items more clearly.

In some embodiments, as shown in FIG. 2A, the set of interactive components 220 is a first set of interactive components.

In some embodiments, with continued reference to FIG. 2B, the electronic device 110 may, in response to receiving the first operation, in association with the second text container 225, a second set of interactive components 230 associated with the content item. The second set of interactive components 230 may include some or all of the components of the set of interactive components 220. The second set of interactive components 230 may be used for the interaction of the user with the content item in the play page 200B.

In some embodiments, with continued reference to FIG. 2B, the electronic device 110 may further, in response to receiving the first operation, cease playing an audio content (e. g., a background music or other audio contents, etc.) corresponding to the content item.

In some embodiments, with continued reference to FIG. 2B, the electronic device 110 may further, in response to receiving the first operation, provide an audio control 235 in the play page 200B. Further, the electronic device 110 may further play an audio content corresponding to the content item based on the selection of the audio control 235 (e. g., a click operation). Further, the electronic device 110 may further cease playing the audio content corresponding to the content item based on a re-selection of the audio control 235. That is, based on the trigger of the audio control 235, the play and pause of the audio content corresponding to the content item can be achieved.

In some embodiments, with continued reference to FIG. 2B, the electronic device 110 may further, in response to receiving the first operation, present prompt information in the play page 200B. The prompt information may indicate a second operation that may be configured to present a detail page of the content item.

In some embodiments, with continued reference to FIG. 2B, the electronic device 110 may, in response to receiving the second operation on the play page 200B, present a detail page of the content item.

In some embodiments, the second operation may include a first sliding operation of sliding the second text container 225 in a first direction. As an example, the first direction may be, for example, a direction from the second text container 225 to the content item play area 205.

In some embodiments, with continued reference to FIG. 2C, the electronic device 110 may further, in response to receiving a second sliding operation of sliding the second text container 225 in a second direction, present a play page of the content item to present the first text container 210. As an example, the second direction may be a direction opposite to the first sliding direction. For example, the second direction may be a direction from the content item play area 205 to the second text container 225.

In some embodiments, with continued reference to FIG. 2B, electronic device 110 may, in response to receiving a left-right sliding operation for the play area 205, switch to view different images in the content item. In some embodiments, when sliding to present the last image of the content item, the electronic device 110 may display a recommended page associated with the content item based on a further sliding operation of the last image.

For example, the content item may be a multi-image content item including a plurality of images, and the electronic device 110 may, in response to a received leftward sliding operation, control the play area 205 to sequentially present the images of the plurality of images. Further, when the play area 205 displays the last image, the electronic device 110 may present a recommended page associated with the current content item based on the received leftward sliding operation to present associated one or more content items.

In some embodiments, with continued reference to FIG. 2B, the electronic device 110 may further, in response to receiving the first operation, present a part of the plurality of labels (i. e., folding display for the plurality of labels) based on the second text container 225.

In some embodiments, with continued reference to FIG. 2B, the electronic device 110 may further provide a presenting control associated with the plurality of labels in the second text container 225. Further, the electronic device 110 may further, in response to a trigger of the display control, present the detail page.

In some embodiments, with reference to FIG. 2C, the electronic device 110 may, in response to receiving the second operation, present a detail page 200C of the content item. The electronic device 110 may provide a third text container 240 in the detail page 200C. The third text container 240 may be configured to present third text content associated with a content item.

In some embodiments, the third text container 240 may further present a full content of the plurality of labels.

In some embodiments, the third text content may include a full text content of the content item and/or a review content of the content item. By way of example, the full text content of the content item may include a title of the content item, an author name, a content item introduction, etc. By way of example, the review content of a content item may include, among other things, the review content associated with the content item published by other users (other than the author of the content item), and the commenting time.

Based on the processes described above, embodiments of the present disclosure can provide a transition page between a play page and a detail page of a content item. The layout is adjusted in the transition page, highlighting the display of the content item. Thus, the user can more conveniently view the content of the content item in the transition page. In addition, the user can naturally jump smoothly from the transition page to the detail page, thereby improving the presenting efficiency of the content of the detail page of the content item and the user experience.

### Example Processes

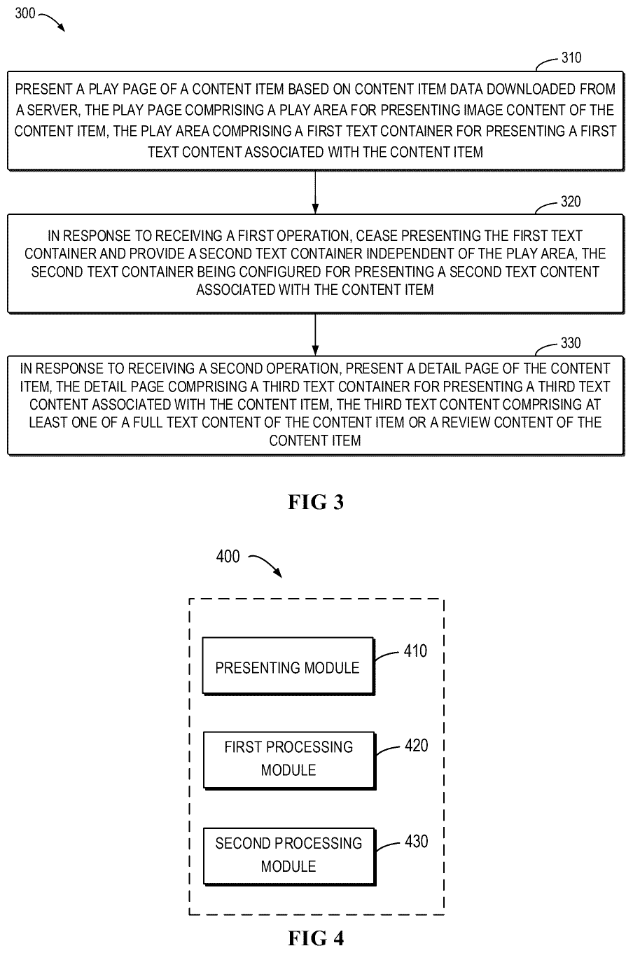

FIG. 3 illustrates a flowchart of an example process 300 of interface interaction according to some embodiments of the disclosure. The process 300 may be implemented at electronic device 110 and is described below with reference to FIG. 1.

As shown, at block 310, the electronic device 110 may present a play page of a content item based on content item data downloaded from a server, the play page comprising a play area for presenting image content of the content item, the play area comprising a first text container for presenting a first text content associated with the content item.

At block 320, the electronic device 110 may, in response to receiving a first operation, cease presenting the first text container and provide a second text container independent of the play area, the second text container being configured for presenting a second text content associated with the content item.

At block 330, electronic device 110 may, in response to receiving a second operation, present a detail page of the content item, the detail page comprising a third text container for presenting a third text content associated with the content item, the third text content comprising a full text content of the content item and/or a review content of the content item.

In some embodiments, the play page is configured to play the content item and the content item comprises a video or a plurality of images, the method 300 further comprising: in response to receiving the first operation, ceasing playing the content item.

In some embodiments, the play area further comprises a set of interaction controls associated with the content item, the method 300 further comprising: in response to receiving the first operation, ceasing presenting the set of interaction controls.

In some embodiments, the set of interactive components comprise a first set of interactive components, the method 300 further comprising: in response to receiving the first operation, providing, in association with the second text container, a second set of interaction controls associated with the content item.

In some embodiments, the method 300 further comprises: in response to receiving the first operation, ceasing playing an audio content corresponding to the content item.

In some embodiments, the method 300 further comprises: in response to receiving the first operation, providing an audio control; and playing, based on a selection of the audio control, the audio content corresponding to the content item.

In some embodiments, the first text container further presents a plurality of labels associated with the content item, the method 300 further comprising: in response to receiving the first operation, presenting a part of the plurality of labels based on the second text container.

In some embodiments, the second text container provides a presenting control associated with the plurality of labels, the method 300 further comprising: in response to a trigger of the presenting control, presenting the detail page, the third text container in the detail page presenting a full content of the plurality of labels.

In some embodiments, the second operation comprises a first sliding operation on the second text container in a first direction.

In some embodiments, the method 300 further comprises: in response to receiving a second sliding operation on the second text container in a second direction, presenting the play page of the content item to present the first text container.

In some embodiments, the second text container has a predetermined size, the predetermined size being independent of a length of the full text content of the content item.

### Example Apparatus and Device

Embodiments of the present disclosure further provide corresponding apparatuses for implementing the above methods or processes. FIG. 4 illustrates a schematic structural block diagram of an example apparatus 400 for interface interaction according to some embodiments of the present disclosure. The apparatus 400 may be implemented as or included in an electronic device. The various modules/components in the apparatus 400 may be implemented by hardware, software, firmware, or any combination thereof.

As shown in FIG. 4, the apparatus 400 comprises a presenting module 410 configured to present a play page of a content item based on content item data downloaded from a server, the play page comprising a play area for presenting image content of the content item, the play area comprising a first text container for presenting a first text content associated with the content item; a first processing module 420 configured to, in response to receiving a first operation, ceasing present the first text container and providing a second text container independent of the play area, the second text container being configured for presenting a second text content associated with the content item; and a second processing module 430 configured to, in response to receiving a second operation, present a detail page of the content item, the detail page comprising a third text container for presenting a third text content associated with the content item, the third text content comprising a full text content of the content item and/or a review content of the content item.

In some embodiments, the presenting module 410 is further configured that: the play page is configured to play the content item and the content item comprises a video or a plurality of images, in response to receiving the first operation, ceasing playing the content item.

In some embodiments, the presenting module 410 is further configured that: the play area further comprises a set of interaction controls associated with the content item, and the first processing module 420 is further configured to: in response to receiving the first operation, cease presenting the set of interaction controls.

In some embodiments, the presenting module 410 is further configured to: he set of interactive components comprise a first set of interactive components, and the first processing module 420 is further configured to: in response to receiving the first operation, provide, in association with the second text container, a second set of interaction controls associated with the content item.

In some embodiments, the first processing module 420 is further configured to: in response to receiving the first operation, cease playing an audio content corresponding to the content item.

In some embodiments, the first processing module 420 is further configured to: in response to receiving the first operation, provide an audio control; and play, based on a selection of the audio control, the audio content corresponding to the content item.

In some embodiments, the presenting module 410 is further configured that: the first text container further presents a plurality of labels associated with the content item, and the first processing module 420 is further configured to: in response to receiving the first operation, present a part of the plurality of labels based on the second text container.

In some embodiments, the presenting module 410 is further configured that: the second text container provides a presenting control associated with the plurality of labels, and the first processing module 420 is further configured to: in response to a trigger of the presenting control, present the detail page, the third text container in the detail page presenting a full content of the plurality of labels.

In some embodiments, the second processing module 430 is further configured that: the second operation comprises a first sliding operation on the second text container in a first direction.

In some embodiments, the second processing module 430 is further configured to: in response to receiving a second sliding operation on the second text container in a second direction, present the play page of the content item to present the first text container.

In some embodiments, the presenting module 410 is further configured that: the second text container has a predetermined size, the predetermined size being independent of a length of the full text content of the content item.

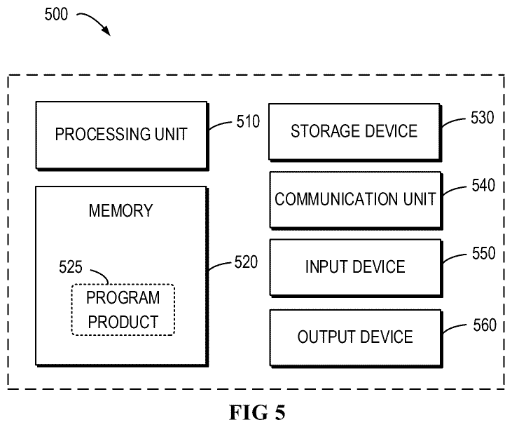

FIG. 5 illustrates a block diagram of an electronic device 500 in which one or more embodiments of the present disclosure may be implemented. It should be appreciated that the electronic device 500 shown in FIG. 5 is merely example and should not constitute any limitation on the functionality and scope of the embodiments described herein. The electronic device 500 shown in FIG. 5 can be used as an electronic device.

As shown in FIG. 5, the electronic device 500 is in the form of a generic electronic device. The components of the electronic device 500 may include, but are not limited to, one or more processors or processing units 510, a memory 520, a storage device 530, one or more communication units 540, one or more input devices 550, and one or more output devices 560. The processing unit 510 may be a real or virtual processor and may be capable of performing various processes according to programs stored in the memory 520. In a multiprocessor system, a plurality of processing units execute computer executable instructions in parallel to improve the parallel processing capability of the electronic device 500.

The electronic device 500 typically includes a plurality of computer storage media. Such media may be any available media that is accessible to the electronic device 500, including, but not limited to, volatile and non-volatile media, removable and non-removable media. The memory 520 may be volatile memory (e. g., registers, cache, random access memory (RAM)), non-volatile memory (e. g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that may be configured to store information and/or data and that may be accessed within electronic device 500.

The electronic device 500 may further comprise additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Accordingly, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speakers, printer, etc. The electronic device 500 may further communicate with one or more external devices (not shown), such as storage devices, display devices, etc., as needed through the communication unit 540, with one or more devices that enable a user to interact with the electronic device 500, or with any device (e. g., network card, modem, etc.) that enables the electronic device 500 to communicate with one or more other electronic devices. Such communication may be performed via an input/output (I/O) interface (not shown).

According to an exemplary implementation of the present disclosure, a computer-readable storage medium is provided, on which a computer-executable instruction is stored, wherein the computer-executable instruction is executed by a processor to implement the above-described method. According to an example implementation of the present disclosure, a computer program product is further provided, which is tangibly stored on a non-transitory computer-readable medium and includes computer-executable instructions that are executed by a processor to implement the method described above.

Various aspects of the present disclosure are described herein with reference to flowcharts and/or block diagrams of a method, apparatus, device, and computer program product implemented according to the present disclosure. It should be understood that each block of the flowchart and/or block diagram, as well as combinations of blocks in the flowchart and/or block diagram, may be implemented by computer-readable program instructions.

These computer-readable program instructions may be provided to a processing unit of a general-purpose computer, a special-purpose computer, or other programmable data-processing apparatus, thereby producing a machine such that the instructions, when executed through the processing unit of the computer or other programmable data-processing device, produce an apparatus that implements the functions/actions specified in one or more of the blocks in the flowchart and/or the block diagram. It is also possible to store these computer-readable program instructions in a computer-readable storage medium, which instructions cause the computer, programmable data processing apparatus and/or other devices to function in a particular manner, whereby the computer-readable medium in which the instructions are stored then comprises an article of manufacture comprising instructions for implementing aspects of the functions/actions specified in the flowchart and/or one or more of the blocks in the block diagram.

Computer-readable program instructions may be loaded onto a computer, other programmable data processing apparatuses, or other apparatuses such that a series of operational steps are performed on the computer, other programmable data processing apparatuses, or other devices to produce a computer-implemented process. Such that the instructions performed on the computer, other programmable data processing apparatuses, or other devices implement the flowchart and/or block diagrams the function/action specified in one or more blocks in the flowchart and/or block diagram.

The flowcharts and block diagrams in the accompanying drawings show the architecture, functionality, and operations that may be implemented in a plurality of implemented systems, methods, and computer program products according to the present disclosure. At this point, each block in the flowcharts or block diagrams may represent a module, program segment, or portion of an instruction, and the module, program segment, or portion of an instruction contains one or more executable instructions for implementing the specified logical functions. In some implementations as replacements, the functions labeled in the blocks may also occur in a different order than those labeled in the accompanying drawings. For example, two consecutive blocks may actually be executed substantially in parallel, and they may sometimes be executed in reverse order, depending on the function involved. It should also be noted that each of the blocks in the block diagrams and/or flowcharts, and combinations of the blocks in the block diagrams and/or flowcharts, may be implemented with a specialized hardware-based system that performs the specified function or action, or may be implemented with a combination of specialized hardware and computer instructions.

Various embodiments of the present disclosure have been described above, and the foregoing description is exemplary, not exhaustive, and is not limited to the disclosed embodiments. Without departing from the scope and spirit of the illustrated implementations, many modifications and changes will be apparent to one of ordinary skill in the art. The terminology used herein has been chosen to best explain the principles of the implementations, the practical applications or improvements to the technology in the marketplace, or to enable others of ordinary skill in the art to understand the various implementations disclosed herein.

1. A method of interface interaction, comprising:
presenting a play page of a content item based on content item data downloaded from a server, the play page comprising a play area for presenting image content of the content item, the play area comprising a first text container for presenting a first text content associated with the content item;
in response to receiving a first operation, ceasing presenting the first text container and providing a second text container independent of the play area, the second text container being configured for presenting a second text content associated with the content item; and
in response to receiving a second operation, presenting a detail page of the content item, the detail page comprising a third text container for presenting a third text content associated with the content item, the third text content comprising at least one of a full text content of the content item or a review content of the content item.

2. The method of claim 1, wherein the play page is configured to play the content item and the content item comprises a video or a plurality of images, the method further comprising:
in response to receiving the first operation, ceasing playing the content item.

3. The method of claim 1, wherein the play area further comprises a set of interaction controls associated with the content item, the method further comprising:
in response to receiving the first operation, ceasing presenting the set of interaction controls.

4. The method of claim 3, wherein the set of interactive components comprise a first set of interactive components, the method further comprising:
in response to receiving the first operation, providing, in association with the second text container, a second set of interaction controls associated with the content item.

5. The method of claim 1, further comprising:
in response to receiving the first operation, ceasing playing an audio content corresponding to the content item.

6. The method of claim 5, further comprising:
in response to receiving the first operation, providing an audio control; and
playing, based on a selection of the audio control, the audio content corresponding to the content item.

7. The method of claim 1, wherein the first text container further presents a plurality of labels associated with the content item, the method further comprising:
in response to receiving the first operation, presenting a part of the plurality of labels based on the second text container.

8. The method of claim 7, wherein the second text container provides a presenting control associated with the plurality of labels, the method further comprising:
in response to a trigger of the presenting control, presenting the detail page, the third text container in the detail page presenting a full content of the plurality of labels.

9. The method of claim 1, wherein the second operation comprises a first sliding operation on the second text container in a first direction.

10. The method of claim 9, further comprising:
in response to receiving a second sliding operation on the second text container in a second direction, presenting the play page of the content item to present the first text container.

11. The method of claim 1, wherein the second text container has a predetermined size, the predetermined size being independent of a length of the full text content of the content item.

12. An electronic device, comprising:
at least one processing unit; and
at least one memory coupled to the at least one processing unit and storing instructions for execution by the at least one processing unit, the instructions, when executed by the at least one processing unit, causing the electronic device to perform the acts comprising:
presenting a play page of a content item based on content item data downloaded from a server, the play page comprising a play area for presenting image content of the content item, the play area comprising a first text container for presenting a first text content associated with the content item;
in response to receiving a first operation, ceasing presenting the first text container and providing a second text container independent of the play area, the second text container being configured for presenting a second text content associated with the content item; and
in response to receiving a second operation, presenting a detail page of the content item, the detail page comprising a third text container for presenting a third text content associated with the content item, the third text content comprising at least one of a full text content of the content item or a review content of the content item.

13. The electronic device of claim 12, wherein the play page is configured to play the content item and the content item comprises a video or a plurality of images, the acts further comprising:
in response to receiving the first operation, ceasing playing the content item.

14. The electronic device of claim 12, wherein the play area further comprises a set of interaction controls associated with the content item, the acts further comprising:
in response to receiving the first operation, ceasing presenting the set of interaction controls.

15. The electronic device of claim 14, wherein the set of interactive components comprise a first set of interactive components, the acts further comprising:
in response to receiving the first operation, providing, in association with the second text container, a second set of interaction controls associated with the content item.

16. The electronic device of claim 12, wherein the acts further comprise:
in response to receiving the first operation, ceasing playing an audio content corresponding to the content item.

17. The electronic device of claim 16, wherein the acts further comprise:
in response to receiving the first operation, providing an audio control; and
playing, based on a selection of the audio control, the audio content corresponding to the content item.

18. The electronic device of claim 12, wherein the first text container further presents a plurality of labels associated with the content item, the acts further comprising:
in response to receiving the first operation, presenting a part of the plurality of labels based on the second text container.

19. The electronic device of claim 18, wherein the second text container provides a presenting control associated with the plurality of labels, the acts further comprising:
in response to a trigger of the presenting control, presenting the detail page, the third text container in the detail page presenting a full content of the plurality of labels.

20. A non-transitory computer readable storage medium having a computer program stored thereon, the computer program being executable by a processor to implement the acts comprising:
presenting a play page of a content item based on content item data downloaded from a server, the play page comprising a play area for presenting image content of the content item, the play area comprising a first text container for presenting a first text content associated with the content item;
in response to receiving a first operation, ceasing presenting the first text container and providing a second text container independent of the play area, the second text container being configured for presenting a second text content associated with the content item; and
in response to receiving a second operation, presenting a detail page of the content item, the detail page comprising a third text container for presenting a third text content associated with the content item, the third text content comprising at least one of a full text content of the content item or a review content of the content item.
